(19) United States
(12) Patent Application Publication
(10) Pub. No.: US 2007/0179933 A1
(43) Pub. Date: Aug. 2, 2007

(54) Method and system for providing information on article of commerce

(75) Inventors: Gook Young Lee, Seoul (KR); Jeong Ok Choe, Seoul (KR)

Correspondence Address: BLACKWELL SANDERS PEPER MARTIN LLP, 720 OLIVE STREET, SUITE 2400, ST. LOUIS, MO, 63101, US

(73) Assignee: NHN CORPORATION, Kyunggi-do (KR)

(21) Appl. No.: 10/599,606

(22) PCT Filed: Apr. 7, 2005
(86) PCT No.: PCT/KR05/00994

§ 371 Date: Oct. 3, 2006

(30) Foreign Application Priority Data
Apr. 7, 2004 (KR) 10-2004-0023614

(51) Int. Cl. G06F 17/30

(52) U.S. Cl. 707/3

(57) ABSTRACT

Disclosed is a method for generating a list of search results of goods in response to a search request for goods of a searcher and providing the searcher with goods information, the method comprising the steps of: maintaining a goods information database for storing a search listing including seller identification information and selling price information; receiving a search request for goods including a keyword from a searcher; in response to the search request for goods, abstracting at least one search listing associated with the keyword from the goods information database, generating a list of search results of goods and transmitting the same to the searcher; receiving a click selection with respect to any one search listing among the list of search results of goods from the searcher; in response to the received click selection, generating and storing total selling price information by referring to selling price information included in the selected search listing; and generating advertising costs of selling price of each seller in accordance with a predetermined selling commission rate by referring to the stored total selling price information; wherein, in the step of generating total selling price information, the selling price of the selected search listing for each seller is added up by referring to seller identification information included in the selected search listing during a first selling period.

### TECHNICAL FIELD

The present invention relates to method and system for generating a list of search results of goods in response to a search request for goods of a searcher and providing the searcher with goods information. More particularly, the present invention relates to method and system for providing goods information, which respectively compute advertisings costs under different conditions on the basis of the number of inputted clicks during a predetermined period and the total selling price causing inputting of clicks and determine advertising costs corresponding to a predetermined condition among the computed advertising costs to be an actual charge amount.

### BACKGROUND ART

Along with popularization of the Internet, distribution and sales of goods and commodities using Internet shopping malls become active. Thus, the number of Internet shopping malls increases incredibly and each of Internet shopping mall providers operates his/her own Internet shopping mall by adopting a mall-in-mall method, in order to facilitate a user's access. The mall-in-mall method may be a method enabling the user to access each shopping mall through a predetermined intermediary shopping mall. Particularly, a price comparison function in the mall-in-mall method is a service which can be easily realized due to characteristics of the intermediary shopping mall in contact with a plurality of Internet shopping malls. The price comparison function of each intermediary shopping mall can satisfy desire of the user who wants to purchase more various goods through comparison between prices. Thus, the service is now being expanded gradually.

That is, shopping malls supporting the price comparison function may be a kind of intermediary shopping malls which collect and process selling price information of each Internet shopping mall with respect to particular goods and provide the processed selling price information to the user who has asked price comparison. At this time, general shopping malls supporting the price comparison function computes advertising costs based on the number of times that selling price information associated with the Internet shopping is exposed to users, or the number of clicks inputted by users with respect to the selling price information, which is intended to obtain more detailed information on goods and make more substantial purchasing.

However, the selling price of each goods is not considered in computing advertising costs based on the number of exposures/the number of clicks. Thus, this might deteriorate equity in computing of advertising costs. For example, in computing advertising costs based on the number of exposures/the number of clicks, in case that advertising costs for ‘one million won’ refrigerator and those for ‘one thousand won’ cable are computed alike on the same number of exposures/clicks, in the worst case, an advertiser advertising ‘one thousand won’ cable may have to pay more advertising costs than sales through the advertising. Thus, there is a problem that the advertiser avoids advertising itself with respect to low-priced goods.

To solve the problem, a method of computing advertising costs based on substantial sales with respect to advertised goods is suggested. For example, appropriate advertising costs are computed by applying predetermined weight to sales suggested by the advertiser. However, there may be a lack of credibility on sales information suggested by the advertiser. In case that the advertiser suggests low sales intentionally, there is a disadvantage that it is impossible to compute appropriate advertising costs. In addition, in case that the number of clicks of users is not considered in computing advertising costs based on sales, there is a problem that advertising costs may be computed highly even when the number of inputted clicks with respect to selling price information is small.

Accordingly, in computing advertising costs, it is required a new type of a price comparison service model considering both the selling price and the number of inputted clicks. At this time, the price comparison service model computes advertising costs based on the selling price of price comparison information associated with the click inputted by the user and advertising costs based on the number of inputted clicks. Also, the price comparison service model solves problems contained in the both and computes advertising costs corresponding to the optimal condition. In addition, there is also required another price comparison service model, which can bring the maximum advertising effects at low advertising costs. At this time, the price comparison service model computes advertising costs with respect to a next selling period according to a trend of clicks inputted by users and charges the advertiser the computed advertising costs. However, the price comparison service model does not charge the advertiser advertising costs during the first selling period only for the advertiser continuously maintaining advertising.

### DISCLOSURE OF THE INVENTION

### Technical Goals

The present invention is conceived to solve the aforementioned problems. Thus, the present invention provides method and system for providing goods information, which can compute advertising costs respectively by referring to the number of inputted clicks during a predetermined period and the total selling price of goods causing inputting of clicks and can determine supplementary advertising costs by charging a seller advertising costs whose comparative size is determined to be smaller as estimated advertising costs.

The present invention also provides method and system for providing goods information, which can clearly confirm price information on the same goods at each of Internet shopping malls by sorting a search listing abstracted in correspondence to a keyword in accordance with selling price information and also can provide fine goods at low prices by encouraging price competition between Internet shopping malls.

The present invention also provides method and system for providing goods information, which can prevent a seller from leaving halfway by providing free advertising with respect to a first selling period only for the seller who continues to maintain advertising with respect to a second selling period, by using advertising deposit received from the seller.

### Technical Solutions

In order to achieve the above goals, according to an aspect of the present invention, there is provided a method for generating a list of search results of goods in response to a search request for goods of a searcher and providing the searcher with goods information, the method including the steps of: maintaining a goods information database for storing a search listing including seller identification information and selling price information; receiving a search request for goods including a keyword from a searcher; in response to the search request for goods, abstracting at least one search listing associated with the keyword from the goods information database, generating a list of search results of goods and transmitting the same to the searcher; receiving a click selection with respect to any one search listing among the list of search results of goods from the searcher; in response to the received click selection, generating and storing total selling price information by referring to selling price information included in the selected search listing; and generating advertising costs of selling price for each seller in accordance with a predetermined selling commission rate by referring to the stored total selling price information; wherein, in the step of generating total selling price information, the selling price of the selected search listing for each seller is added up by referring to seller identification information included in the selected search listing during a first selling period.

Furthermore, according to another aspect of the present invention, there is provided a system for providing goods information, the system including: a goods information database for storing a search listing including seller identification information and selling price information; an interface means receiving a search request for goods including a keyword from a searcher; a list generating means, in response to the search request for goods, abstracting at least one search listing associated with the keyword from the goods information database, generating a list of search results of goods and transmitting the same to the searcher; a record control means, in response to the received click selection of the searcher selecting any one search listing among the list of search results of goods, generating and storing click selection information and total selling price information with respect to a first selling period for each seller; a first advertising costs generating means generating predetermined advertising costs of selling price and cost-per-click information by referring to the stored total selling price information and click selection information; a second advertising costs generating means generating estimated advertising costs information with respect to a second selling period, based on the generated advertising costs of selling price and cost-per-click information.

### BRIEF DESCRIPTION OF DRAWINGS

FIG. 1 is a view illustrating schematic operations of a system for providing goods information according to the present invention;

FIG. 2 is a configuration diagram illustrating a system for providing goods information according to a preferred embodiment of the present invention;

FIG. 3 is a view illustrating one example of configuration of a goods information database storing a search listing according to the present invention, FIG. 4 is a view illustrating one example of a list of search results of goods in which the abstracted search listing is sorted in order of the selling price, FIG. 5 is a view illustrating one example of storing total selling price information and click selection information generated by a record control means, and FIG. 6 is a view illustrating one example of setting a selling commission rate;

FIG. 7 is a flowchart illustrating a method for providing goods information according to a preferred embodiment of the present invention and FIG. 8 is a flowchart illustrating one example of a method for generating cost-per-click information and estimated advertising costs;

FIG. 9 is a flowchart illustrating one example of a method for sorting a search listing provided in a list of search results of goods of the present invention and FIG. 10 is a flowchart illustrating one example of a method for performing truncation with respect to estimated advertising costs;

FIG. 11 is a flowchart illustrating one example of a method for determining advertising costs of a selling period based on payment of advertising deposit according to the present invention;

FIG. 12 is a flowchart illustrating one example of a method for generating detailed search information on a search trend of a searcher according to the present invention; and

FIG. 13 is an inner block diagram of a general-purpose computer which can be adopted in implementing a method for providing goods information according to the present invention.

### BEST MODE FOR CARRYING OUT THE INVENTION

Hereinafter, method and system for providing goods information according to the present invention will be described with reference to the accompanying drawings.

Advertising costs continuously used in the present specification may be a commission generating when a searcher provided with a price comparison service for goods is connected to a particular online shopping mall where the searcher can purchase the goods. Advertising costs include cost-per-click information which is based on the number of times that searchers are connected to the online shopping mall and advertising costs of selling price which are based on the selling price of goods at the online shopping mall inducing the access of the searcher. In the present embodiment, the cost-per-click information is compared with the advertising costs of selling price and lower advertising costs therebetween is charged to a predetermined seller (a server party associated with operation of the Internet shopping mall) as estimated advertising costs. In addition, a web server of the present invention may be an intermediary shopping mall server which provides the searcher with goods information in interoperation with at least one shopping mall. At this time, it will be preferable that the web server is a shopping mall server for price comparison, which compares selling price information of each Internet shopping mall with respect to one particular goods and provides the searcher with results of comparison.

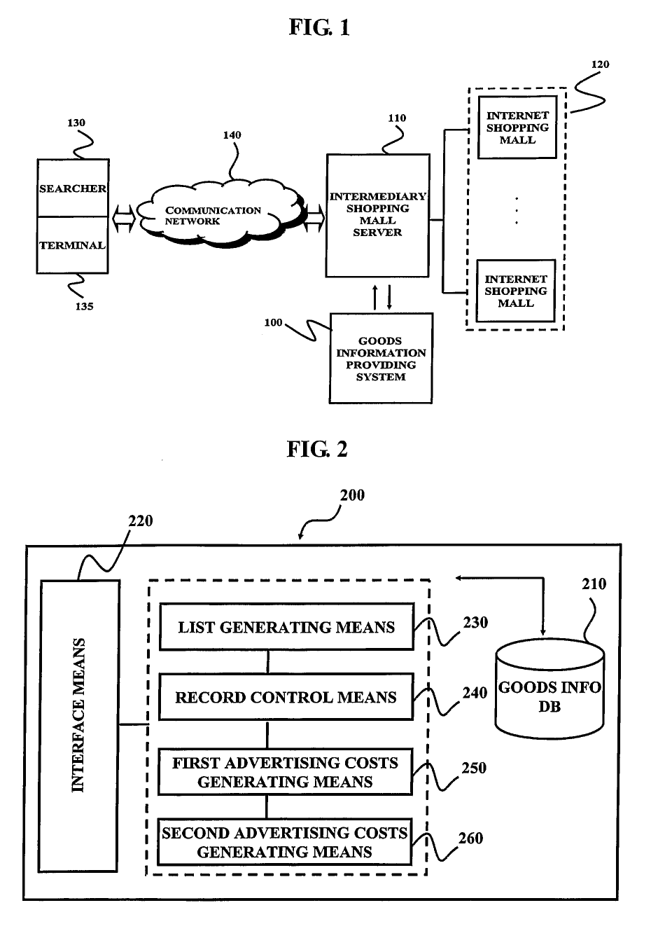

FIG. 1 is a view illustrating schematic operations of a system for providing goods information according to the present invention.

A goods information providing system 100 generates a predetermined size of advertising costs when a searcher 130 clicks goods information which is provided in response a search request for goods, i.e., when the searcher 130 is induced to access a particular Internet shopping mall 120.

First, an intermediary shopping mall server 110 is under a predetermined service contract with a plurality of Internet shopping mall servers 120 and connected thereto 120. At this time, the intermediary shopping mall server 110 serves to collect a list of goods maintained in each of Internet shopping mall servers 120. A list of collected goods is processed to be predetermined goods information in accordance with a predetermined criterion. In case that a search request for goods including a keyword is received from the searcher 130, the intermediary shopping mall server 110 abstracts goods information corresponding to the keyword and provides the searcher 130 with the abstracted goods information. That is, the intermediary shopping mall server 110 collects, classifies, and processes a large quantity of goods information in order to best achieve the search request for goods of the searcher 130. Particularly, in processing goods information, the intermediary shopping mall server 110 has a price comparison function, enabling the searcher 130 to clearly compare and confirm the selling price of each Internet shopping mall server 120 with respect to particular one piece of goods. Through the function of the intermediary shopping mall server 110, the searcher 130 can easily obtain detailed information on goods and information on the Internet shopping mall suggesting a lower selling price. In addition, when a request for access to the particular Internet shopping mall server 120 is received from the searcher 130 provided with goods information (including price comparison information), the intermediary shopping mall server 110 collects the searcher 130 to the Internet shopping mall server 120 and induces the searcher 130 to purchase goods substantially.

The Internet shopping mall server 120 serves to realize e-commerce which makes trading of goods or commodities possible on the Internet. Therefore, the Internet shopping mall server 120 enables goods to be distributed smoothly by connecting a consumer (searcher 130) who wants to purchase goods to a maker who wants to sell the goods. At this time, since the selling price of goods suggested at the Internet shopping mall server 120 is determined in accordance with respectively different distribution and sales strategies, the selling price may be different at each Internet shopping mall server 120 with respect to the same goods.

The searcher 130 may be an Internet user who generates a predetermined search request for goods to search for information on particular goods or to compare prices and is provided with goods information from the intermediary shopping mall server 110 responding to the request. That is, the searcher 130 may be an Internet user who has a terminal 135 to access the intermediary shopping mall server 10 and generates a search request for wanted goods, for example, by transmitting a name of goods to the intermediary shopping mall server 110.

The terminal 135 maintains a connection state with the goods information providing system 100 through a communication network 140, such as the Internet and the like. The terminal 135 displays at least one piece of goods information on a predetermined screen and goods information is abstracted by searching goods. The terminal 135 may be a general concept for terminals with a computing function by mounting a predetermined memory means and a predetermined microprocessor, such as for example, personal computers, handheld computers, Personal Digital Assistants, MP3 players, electric dictionaries, cellular phones, smart phones, and the like.

The goods information providing system 100 generates advertising costs when the searcher 130 is connected to the Internet shopping server 120. At this time, the goods information providing system 100 serves to generate two different advertising costs, in which one is advertising costs based on access connection of the searcher 130 (cost-per-click information) and the other is advertising costs based on the selling price of goods causing the access connection of the searcher 130 (advertising costs of selling price). In addition, the goods information providing system 100 determines only one between the cost-per-click information and the advertising costs of selling price as estimated advertising costs to be actually charged. Thus, it is possible to charge more reasonable and economical advertising costs with respect to corresponding goods.

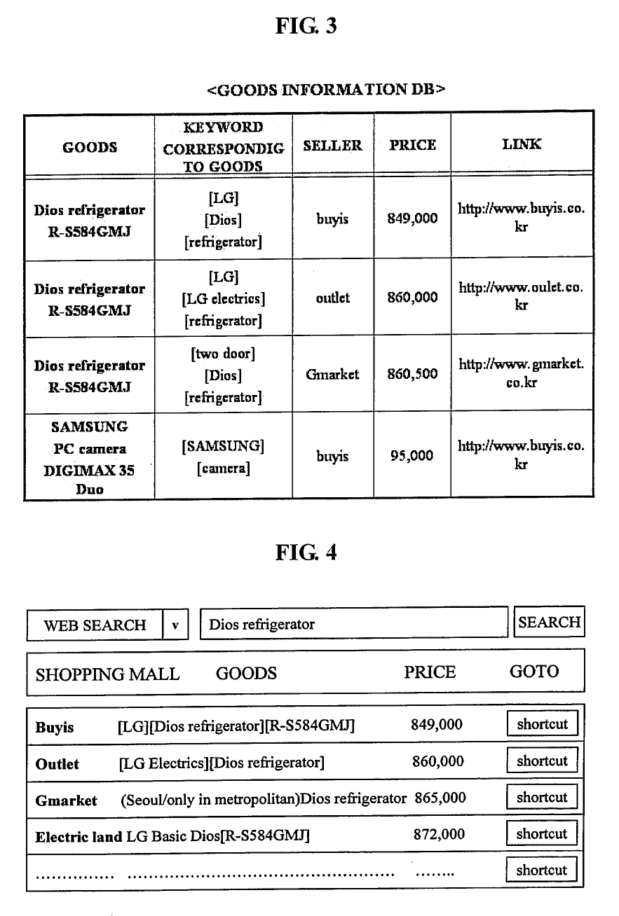

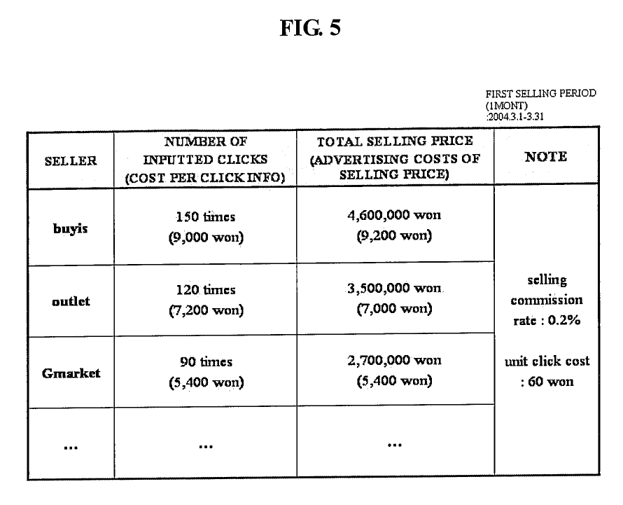

Hereinafter, a goods information providing system 200 of the present invention will be fully described with reference to FIG. 2.

FIG. 2 is a configuration diagram illustrating a system for providing goods information according to a preferred embodiment of the present invention.

The goods information providing system 200 includes a goods information database 210, an interface means 220, a list generating means 230, a record control means 240, a first advertising costs generating means 250 and a second advertising costs generating means 260.

First, the goods information database 210 stores a search listing including seller identification information and selling price information. At this time, the seller identification information may be recognition data identifying Internet shopping malls and the selling price information may be price data on the selling price suggested by Internet shopping malls with respect to predetermined goods. That is, the search listing includes information on internet shopping malls selling the goods and information on the selling price thereof. The goods information database 210 serves to maintain the search listing. The search listing is one piece of goods information which is abstracted in correspondence to a keyword inputted into the intermediary shopping mall server 110 by the searcher 110 and provided to the searcher as search results.

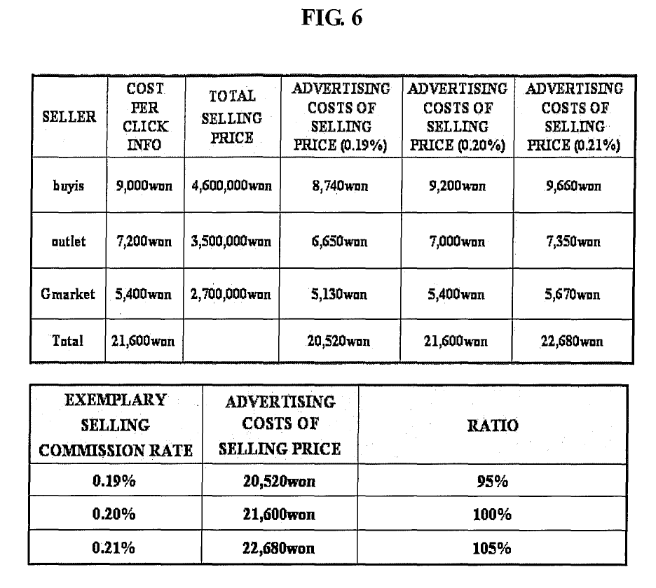

In addition, in response to a click selection of the searcher 130 with respect o a predetermined search listing, the goods information providing system 200 may further include a record field (not illustrated) for storing predetermined detailed click information associated with the selected search listing. At this time, the record field may be a record device for temporarily storing detailed click information generating within a set period. That is, the goods information providing system 200 stores ‘number information (No)’, ‘product name information (pname)’, ‘product model identification information (nv_mid)’, ‘seller identification information (mall_id)’, ‘searcher identification information (user_id)’, ‘selling price information (price)’, ‘click time information (daytime)’, ‘seller type information (type)’, etc. in the record field, in interoperation with a click selection of the searcher 130 and maintains the same during a predetermined period. At this time, ‘number information (No)’ may be numerical data sequentially allocated per click selection of the searcher 130 and other information including ‘the product name information’ are stored in correspondence to ‘number information’. That is, ‘number information’ is a key value per case and may be updated per the predetermined period (e.g., one day, one week, one month, etc) and updated ‘number information’ is allocated to each seller. ‘Product name information (pname)’ is data in relation to names of goods of a selected search listing. ‘Product model identification information (nv_mid) is product identification data being used at each shopping mall. In addition, ‘seller identification information (mall_id) is identification data in relation to a particular shopping mall, ‘searcher identification information (user_id)’ is identification data in relation to the searcher 130 who has selected the search listing, ‘selling price information (price)’ is numerical data in relation to the selling price included in the search listing, ‘click time information (daytime)’ is time data in relation to the clicked time, and ‘seller type information (type)’ is classification data in relation to whether the shopping mall is opened or chosen. For example, in case that a search listing associated with the advertiser ‘buyis’ of FIG. 3 is selected by the searcher ‘kingNHN’, ‘No1, Diosrefrigerator (R-S584GMJ), mall_id ‘buyis’, user_id ‘kingNHN’, 849,000won, 2004-03-16, open mall’ and the like is recorded in the record field. Thus, detailed click information is generated in accordance with a click selection of the searcher 130. At least one piece of generated detailed click information is integrated by periods and accumulated and stored as added information for each seller, as illustrated in FIG. 5. In addition, detailed click information of a previous period stored in the record field is cleared. Data loads are minimized such that detailed click information of the next period can be easily stored.

After ending of the set period, for example after one day, detailed click information stored in the record field becomes a standard to generate information on the number of inputted clicks or information on the total selling price, as illustrated in FIG. 5. For example, the number of inputted clicks is accumulated on the basis of ‘number information’ and the selling price is accumulated on the basis of ‘selling price information’. In FIG. 5, the number of inputted clicks is updated at a point when the period ends. However, this is only one embodiment of the present invention. It is also apparent that detailed click information may continue to be maintained in the goods information database and, for example, may be generated as information on the number of inputted clicks or information on the total selling price.

The interface means 220 receives a search request for goods including a keyword from the searcher 130. That is, the interface means 220 serves to receive an intention of the searcher who wants to be provided with price information of each Internet shopping mall server 120 with respect to particular goods. At this time, the interface means receives, for example, a classified goods name, a brand name, or the like, as a keyword for the search request for goods. For example, as a name of goods to be searched is inputted into a predetermined user interface provided to the searcher 130 by the interface means 220, the search request for goods may be generated. In addition, the interface means 220 has a function of receiving a click connecting signal. The click connecting signal is generated when the searcher 130 clicks a predetermined search listing provided as search results by using an instruction input device such as a computer mouse. In addition, the click connecting signal acts as an instruction control signal enabling the searcher 130 to access a predetermined Internet shopping mall module 120 by the goods information providing system 200 of the present invention.

The list generating means 230 abstracts at least one search listing associated with a keyword from the goods information database 210, in response to a search request for goods, and generates a list of search results of goods. That is, the list generating means 230 determines that a search listing including goods identification information, which is identical to the inputted keyword for searching, is goods information wanted by the searcher 130 and abstracts the search listing. In the present embodiment, as an example, the search listing of goods identification information identical to the keyword is abstracted. However, this is only one embodiment of the present invention. Thus, there may be various methods of abstracting a search listing, such as for example, a method of abstracting a search listing of goods identification information including a portion of an inputted keyword, and the like. In addition, the list generating means 230 generates a list of search results of goods by sorting at least one abstracted search listing in accordance with a predetermined criterion and transmits the generated list of search results of goods to the terminal 135 of the searcher 130 as search results. The predetermined criterion, for example, may include various components such as a registration date of the search listing, popularity thereof, and the like. Preferably, in the present embodiment, the comparative size of selling price information included in the search listing may be set as the criterion. Hereinafter, a search listing and a list of search results of goods will be described with reference to FIGS. 3 and 4.

FIG. 3 is a view illustrating one example of configuration of a goods information database storing a search listing according to the present invention.

As illustrated in FIG. 3, the goods information database 210 stores at least one search listing which is information on particular goods. Each search listing includes ‘sellers’ that are information on Internet shopping malls (selling malls) selling goods and ‘selling price’ that is price information of Internet shopping malls with respect to corresponding goods. Thus, the search listing can be used in the aforementioned price comparison service. In addition, the search listing includes information on ‘keywords corresponding to goods’ which enables the search listing to be abstracted in response to a search request for goods and information on ‘links’ which connects the searcher 130 to a particular Internet shopping mall in accordance with a predetermined click selection. At this time, ‘keywords corresponding to goods’ may be, for example, a kind of goods, a brand name, an advertising phrase, etc, which enables a search listing in relation to a seller to be abstracted when a particular keyword of goods is inputted. A keyword inputted to request a search of goods is considered. ‘Keywords corresponding to goods’ are received from the seller and stored in the goods information database 210. For example, a search listing in relation to the seller ‘buyis’, which is provided in the highest portion of the database, is abstracted as search results when ‘LG’, ‘Dios’, or ‘refrigerator’ is inputted as a keyword.

FIG. 4 is a view illustrating one example of a list of search results of goods in which the abstracted search listing is sorted in order of the selling price.

In FIG. 4, it is assumed that ‘Dios refiigerator’ is inputted as a keyword by the searcher 130 who wants to obtain goods information on ‘LG Dios refrigerator’. Accordingly, the goods information providing system 200 of the present invention abstracts a search listing maintaining ‘Dios’ and ‘refrigerator’ as keywords corresponding to goods from the goods information database 210. For example, the goods information providing system 200 may abstract a search listing associated with the seller ‘buyis’ maintaining ‘Dios’ as a keyword corresponding to goods. At least one abstracted search listing becomes a component of a list of search results of goods provided to the searcher 130 as search results. As illustrated in FIG. 4, the abstracted search listing is sorted in order of a low selling price. Referring to FIG. 4, ‘buyis’ is an Internet shopping mall which suggests the lowest price with respect to ‘LG Dios refrigerator that the searcher 130 wants. The searcher 130 can clearly recognize information on selling price suggested at each of Internet shopping malls with respect to the same goods. In addition, a list of search results of goods in FIG. 4 includes a hot key ‘shortcut’ to access a corresponding Internet shopping mall. Thus, in case that the searcher 130 clicks ‘shortcut’ in order to substantially purchase corresponding goods or obtain more detailed information, the hot key connects the searcher 130 to the Internet shopping mall by referring to ‘link’ information. Clicking of the hot key and the number of inputted clicks become very important elements in computing advertising costs according to the present invention. This will be fully described later. In the present embodiment, as an example, the hot key is provided to a list of search results of goods to access the Internet shopping mall. However, this is only one embodiment of the present invention. For example, there may be various access methods, such as a method of connecting the searcher 130 to the Internet shopping mall by referring to predetermined ‘link’ information in case that a text included in a search listing is hyperlinked and the searcher 130 clicks the text.

Referring to FIG. 2 again, the record control means 240 generates total selling price information and click selection information for each seller with respect to a first selling period, in response to a received click selection of the searcher 130 who selects any one of search listings among a list of search results of goods, and stores the generated total selling price information and click selection information. At this time, the first selling period is any elapsed period that is set by the system operator in order to determine a trend of click selection with respect to the search listing. The record control means 240 adds up the number of inputted clicks with respect to the search listing and the selling price of the search listing inducing the click selection for each seller during the first selling period. That is, the record control means 240 generates the total number of times that searchers 130 are connected through the intermediary shopping mall 110, for each seller as click selection information by referring to seller identification information of the search listing. The record control means 240 adds up the selling price of the search listing inducing a click selection of the searcher 130 and generates total selling price information. In case that there is a click selection from the searcher 130, the total selling price information and the click selection information are updated for each corresponding seller and stored in a predetermined memory means (not illustrated). In addition, the total selling price information and the click selection information are used in computing advertising costs at a point when the first selling period ends. Hereinafter, generating of total selling price information and click selection information will be described with reference to FIG. 5.

FIG. 5 is a view illustrating one example of storing total selling price information and click selection information generated by a record control means of the present invention.

In FIG. 5, it is assumed that one month from 2004.3.1 to 2004.3.31 is set as the first selling period. As an example, there is data with respect to the total number of inputted clicks and the total selling price which is accumulated by the record control means 240 during the first selling period. For example, the number of inputted clicks is ‘150 times’ with respect to a search listing of the seller ‘buyis’. That is, the searcher 130 is controlled to access the Internet shopping mall ‘buyis’ the total of 150 times in accordance with a click of the searcher 130 with respect to the hot key ‘shortcut’. In addition, the total selling price is ‘4,600,000 won’. That is, ‘4,600,000 won’ is the total amount of selling price of the search listing including the hot key ‘shortcut’ which is clicked by the searcher 130. The total selling price information and the click selection information are updated and stored for each seller per click of the searcher 130 during the first selling period. The total selling price information and the click selection information are cleared at a point when the first selling period ends. It is prepared for the number of inputted clicks and adding of selling prices during the next second selling period. For example, in case that a click is inputted for a search listing in relation to ‘Dios refrigerator’ and ‘Samsung PC camera’ which are goods of the advertiser ‘buyis’ in FIG. 3, total selling price information and click selection information records ‘944,000 won’ (=849,000+95,000) for total selling price information and records ‘2 times’ for the number of inputted clicks. Accordingly, the total selling price information and the click selection information enable, for example, the system operator to estimate a trend of inputted clicks of the searcher 130 with respect to the search listing during the first selling period (one month) and to use the same in computing advertising costs during the second selling period.

The first advertising costs generating means 250 generates predetermined advertising costs of selling price and cost-per-click information by referring to the stored total selling price information and click selection information. That is, the first advertising costs generating means 250 serves to compute two respectively different advertising costs by applying respectively set selling commission rate and unit click cost to the total selling price and the number of inputted clicks which are stored at a point when the first selling period ends. As aforementioned, advertising costs of selling price are advertising costs computed based on the selling price included in the search listing. Cost-per-click information is advertising costs based on the number of inputted clicks with respect to the search listing, which is based on the number of times that searchers 130 are connected to the Internet shopping mall. Computing of two respectively different advertising costs is to compute supplementary advertising costs, in order to overcome problems caused in computing costs by the conventional Cost Per Click (CPC) or selling price. For example, in FIG. 5, it is assumed that the selling commission rate is set at 0.2% (×0.002) and the unit click cost is set at 60 won. Accordingly, advertising costs of selling price computed to charge the seller ‘buyis’ are ‘9,200 won’ (=4,600,000×0.002) and cost-per-click information is ‘9,000 won’ (=150×60 won). The selling commission rate or the unit click cost may be flexibly set, adjusted, or changed by the system operator considering system environments. For example, the selling commission rate may be set by a predetermined computing combination of a click commission rate and a purchase success rate. At this time, the selling commission rate may be information in relation to what percentage of selling price of goods is used in computing advertising costs of selling price. More detailed description related thereto will be described later.

The second advertising costs generating means 260 generates estimated advertising costs with respect to the second selling period, based on the generated advertising costs of selling price and cost-per-click information. The second selling period is a period starting when the first selling period ends, for computing advertising costs. In the present embodiment, estimated advertising costs of the second selling period is computed by referring to the stored total selling price information and click selection information of the first selling period. The computed estimated advertising costs are charged to the seller. That is, the second advertising costs generating means 260 compares cost-per-click information with advertising costs of selling price and determines advertising costs whose costs are comparatively low to be estimated advertising costs. Accordingly, in FIG. 5, estimated advertising costs of the second selling period which will be charged to the seller ‘buyis’ are cost-per-click information ‘9000 won’ and estimated advertising costs of the second selling period will be charged to the seller ‘outlet’ are advertising costs of selling price ‘7,000 won’. In addition, estimated advertising costs of ‘5,400 won’ are charged to the seller ‘Gmarket’ whose advertising costs of selling price and cost-per-click information of the first selling period are same. Moreover, the second advertising costs generating means 260 controls a predetermined charging control means (not illustrated) to perform payment processing with respect to estimated advertising costs charged to the seller. For example, the second advertising costs generating means 260 subtracts corresponding estimated advertising costs from a predetermined account associated with the seller.

Accordingly, according to the resent invention, advertising costs which is determined to be a smaller value between advertising costs of selling price and cost-per-click information is provided as estimated advertising costs of the next selling period. Thus, there is an advantage that it is possible to charge sellers reasonably and to bring them more economical and efficient advertising effects.

In the present embodiment, as an example, advertising costs computed to be smaller between advertising costs of selling price and cost-per-click information is determined to be estimated advertising costs. However, this is only one embodiment of the present invention. Also, there may be various methods of determining estimated advertising costs, such as for example, a method of determining the average of advertising costs of selling price and cost-per-click information to be estimated advertising costs.

Hereinafter, as another embodiment of the present invention, it will be described that a seller is induced to continue to maintain advertising by advertising deposit.

As suggested in the aforementioned description of estimated advertising costs, the same with respect to the first selling period of the present invention is not determined limitedly. That is, the first selling period may be an information collection period to compute estimated advertising costs of the second selling period. Advertising costs to be charged with respect to the first selling period is flexibly determined by the system operator. For example, in one embodiment of the present invention, advertising costs of the first selling period may be service compensation and not be charged to the seller. At this time, there may be a seller who abuses the service compensation by maintaining adverting by a search listing during the first selling period only. In order to overcome the above problem, the goods information providing system 200 of the present invention transmits a predetermined size of advertising deposit information to the seller and provides the searcher 130 with advertising by a corresponding search listing, which is goods information, only with respect to the seller who has sent an amount corresponding to the advertising deposit information to an account associated with the seller. The advertising deposit becomes an amount to be charged to the seller (including the seller who terminates advertising within the first selling period), who maintains advertising during the first selling period only that is free of charge, for advertising costs. Thus, the advertising deposit is not refunded to the seller and subtracted for advertising costs. In addition, substantial free advertising effects during the first selling period are achieved by charging the seller who maintains advertising even after the first selling period ends estimated advertising costs in which as much as advertising deposit is subtracted.

Operation flows of the goods information providing system 200 such configured according to the present invention will be fully described.

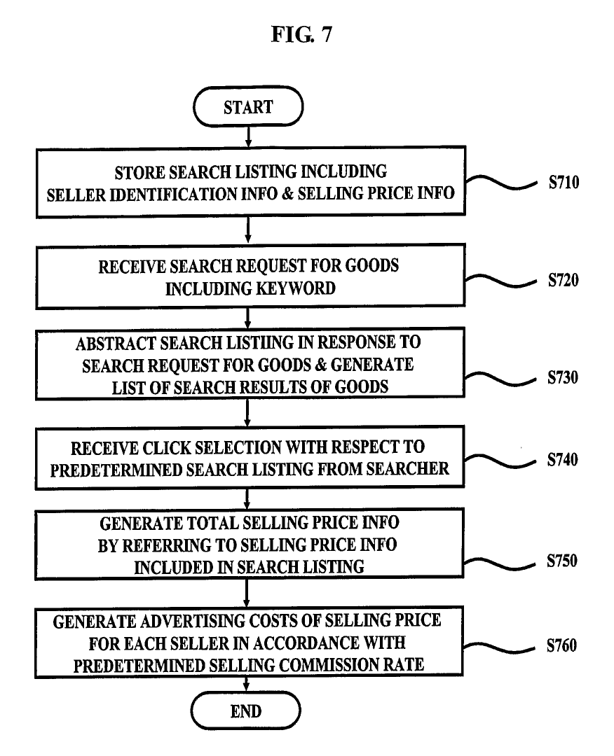

FIG. 7 is a flowchart illustrating a method for providing goods information according to a preferred embodiment of the present invention.

The goods information providing method according to the present embodiment is performed by the aforementioned goods information providing system 200.

First, the goods information providing system 200 maintains the goods information database 210 for storing a search listing including seller identification information and selling price information (S710). This step S710 is a procedure for generating a list of goods maintained in at least one Internet shopping mall server 120 and storing the generated search listing. The search listing includes seller information of the Internet shopping mall selling goods, price information, link information, and the like (refer to FIG. 3).

In addition, the goods information providing system 200 receives a search request for goods including a keyword from the searcher 130 (S720). This step S720 is a procedure for receiving a search request for goods from the searcher 130 who wants to search for information on particular goods such as price comparison. For example, the search request for goods is received when the searcher 130 inputs a corresponding keyword associated with the goods into a user interface which is provided to the terminal 135 of the searcher 130 (refer to FIG. 4).

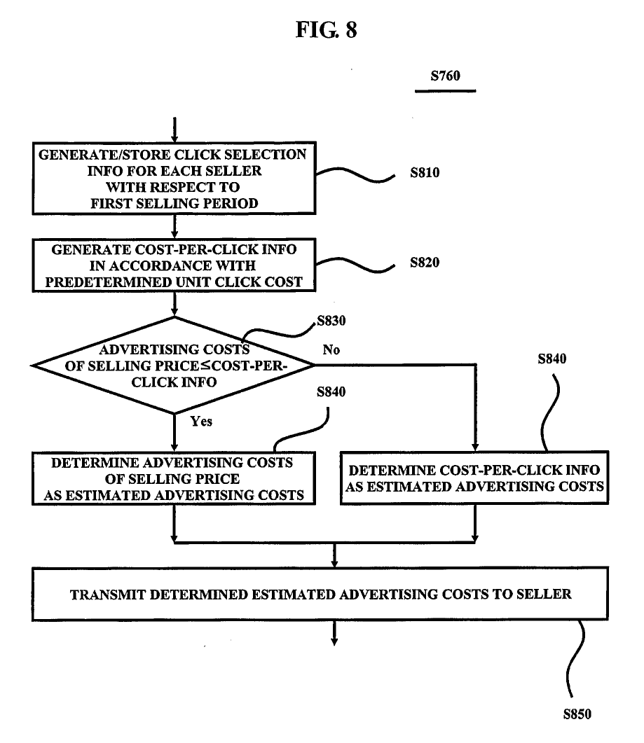

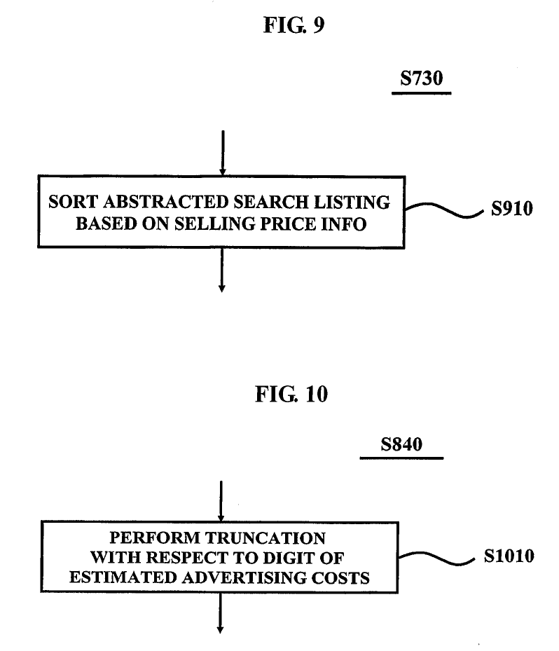

In the next, in response to the received search request for goods, the goods information providing system 200 abstracts at least one search listing associated with the keyword from goods information database 210 and generates a list of search results of goods and transmits the same to the searcher 130 (S730). This step S730 is a procedure for generating a list of search results of goods to be provided as search results by determining optimal goods information wanted by the searcher 130. For example, the goods information providing system 200 determines a search listing including a keyword inputted by the searcher 130 as ‘keyword corresponding to goods’ to be optimal goods information and abstracts the search listing from the goods information database 210. In FIG. 4, a search listing in relation to the seller ‘buyis’ having the keyword ‘Dios refrigerator’ as ‘keyword corresponding to goods’ is abstracted and provided in a list of search results of goods. In addition, the list of search results of goods in the step S730 may be generated to sort the abstracted search listing in accordance with the selling price. This is to achieve the purpose of the present invention, which is a price comparison service. This will be described with reference to FIG. 9.

FIG. 9 is a flowchart illustrating one example of a method for sorting a search listing provided in a list of search results of goods of the present invention.

As illustrated in FIG. 9, the goods information providing system 200 sorts at least one abstracted search listing in accordance with a predetermined order based on selling price information of the search listing (S910). This step S910 is a procedure for generating a list of search results of goods in which the abstracted search listing is sorted based on the selling price suggested at each of Internet shopping malls. Particularly, in this step, the search listing is sorted in order of a low selling price. Accordingly, according to the present invention, there is an effect that the searcher 130 can clearly confirm price information of each of Internet shopping malls with respect to the same goods and it is possible to provide goods at lower prices by causing price competition between Internet shopping malls.

In addition, the goods information providing system 200 receives a click selection with respect to any one search listing among a list of search results of goods from the searcher 130 (S740). This step S740 is a procedure for transmitting an intention of the searcher 130 who wants to access a particular seller to the goods information providing system 200. In this step, a selection with respect to a particular search listing is completed when the searcher 130 provided with price comparison information of goods clicks the search listing, for example, the hot key ‘shortcut’ in order to access a corresponding Internet shopping mall. In addition, in this step S740, the goods information providing system 200 connects the searcher 130 to the corresponding Internet shopping mall server 110 by referring to link information, for example, a URL, an IP address, a domain, etc, included in the clicked search listing. Thus, it is possible to induce the searcher 130 to substantially purchase the goods and to purchase another goods at the same Internet shopping mall.

In the next, in response to the received click selection, the goods information providing system 200 generates total selling price information by referring to selling price information included in the selected search listing and stores the generated total selling price information (S750). This step S750 is a procedure for adding up selling prices of the search listing selected by the searcher 130 during a predetermined period (a first selling period). Particularly, in this step, selling prices are added up for each seller by referring to seller identification information included in the selected search listing. That is, the goods information providing system 200 adds up selling prices of goods inducing access of the searcher 130, for each seller. The goods information providing system 200 generates the total amount of selling prices by the first selling period ends as total selling price information.

In addition, the goods information providing system 200 generates advertising costs of selling price for each seller in accordance with a predetermined selling commission rate, by referring to the stored total selling price information (S760). This step S760 is a procedure for computing advertising costs corresponding to the next selling period (a second selling period) by applying a set selling commission rate to the total amount of selling prices stored as total selling price information. The selling commission rate may be weight to compute advertising costs of selling price and arbitrarily set by the system operator considering system environments. For example, the selling commission rate may be arithmetically set by calculation of [sale commission rate×purchase success rate]. In case that advertising costs are defined based on selling prices, which is from a view point of an Internet shopping mall, the advertising costs are [selling price×selling commission rate] (a first equation). In case that the advertising costs are defined based on sold prices at which substantial purchasing is performed, which is from a view point of a seller, the advertising costs are [sold price×sale commission rate]. At this time, the sold price may be set as [selling price×purchase success rate]. Thus, advertising costs may be defined as [selling price ×purchase success rate×sale commission rate] (a second equation). Comparing the first and the second equations, the selling commission rate may be defined as [sale commission rate×purchase success rate]. Generally, the sale commission rate is arbitrarily by a service provider executing advertising as proxy, preferably the system operator. The purchase success rate may be obtained by collecting information in relation to substantial purchasing of the searcher 130 who is connected to the Internet shopping mall from each of sellers.

Hereinafter, as another embodiment for setting a selling commission rate according to the present invention, setting of the optimal selling commission rate based on cost-per-click information computed during a predetermined will be described.

FIG. 6 is a view illustrating one example of setting a selling commission rate.

In FIG. 6, as an example, the selling commission rate is set based on cost-per-click information for one month, which is computed in FIG. 5. First, the goods information providing system 200 of the present invention computes cost-per-click information and total selling price for each seller by referring to the number of inputted clicks with respect to each seller and selling price. In the next, the goods information providing system 200 applies at least one respectively different exemplary selling commission rate, for example, 0.19%, 0.20%, 0.21%, etc, to the total selling price, generates advertising costs of selling price for each seller and computes the total amount of the generated advertising costs of selling price, based on each of the exemplary selling commission rates. In FIG. 6, when the exemplary commission rate is 0.19%, the total amount of advertising costs of selling price are 20,520 won corresponding to 95% of cost-per-click information ‘21,600 won’. When the exemplary commission rate is 0.20%, the total amount of advertising costs of selling price are 21,600 won corresponding to 100% of cost-per-click information ‘21,600 won’. Accordingly, the goods information providing system 200 determines one exemplary selling commission rate ‘0.20%’, which is applied when the total advertising costs of selling prices are nearest to the total cost-per-click information, to be the selling commission rate to be applied to a corresponding seller. Also, the selling commission rate may be defined respectively differently with respect to each seller, based on a sales trend, a type of advertising contract, or an applied time or period. Therefore, in computing advertising costs, there is an effect that it is possible to compute advertising costs based on the selling price, in order to supplement a problem that there is no equity on the side of a shopping mall having goods at low prices when advertising costs based on cost-per-click information is charged to each seller.

Hereinafter, as another embodiment of the present invention, computing advertising costs based on the number of clicks inputted by the searcher 130 for a search listing will be described.

FIG. 8 is a flowchart illustrating one example of a method for generating cost-per-click information and estimated advertising costs.

In the present embodiment, advertising costs, which is cost-per-click information, is computed based on the number of times that searchers 130 are connected to a particular Internet shopping mall during the first selling period.

For this, in response to a received click selection, the goods information providing system 200 generates click selection information in accordance with each seller of the selected search listing with respect to the first selling period and stores the generated click selection information (S810). This step S810 is a procedure for measuring the total number of times that searchers 130 are connected to the Internet shopping mall server 120, for example, the total number of times that searchers 130 click the hot key ‘shortcut’. Particularly, in this step, the goods information providing system 200 generates click selection information independently for each seller associated with the clicked search listing. Through this, the goods information providing system 200 can statistically confirm the number of searchers 130 that have been connected to each seller during a predetermined period (a selling period). For example, ‘150 times’ is stored as click selection information which is generated during the first selling period in association with the seller ‘buyis’. Thus, it is possible to confirm that the number of searchers 130 who are connected to the Internet shopping mall ‘buyis’ through the intermediary shopping mall 110 of the present invention is 150 persons.

In addition, the goods information providing system 200 generates cost-per-click information according to a predetermined unit click cost, based on click selection information (S820). This step S820 is a procedure for computing advertising costs of the next selling period (a second selling period) by applying the set unit click cost to the number of inputted clicks which is stored as click selection information. That is, the goods information providing system 200 computes cost-per-click information based on the number of times that searchers 130 are connected and enables the computed cost-per-click information to be used to supplement a problem which may be caused by the computed advertising costs of selling price, for example, a problem that advertising costs may be computed to be high because of a high selling price without substantial purchasing. The unit click cost may be weight to compute cost-per-click information and arbitrarily set by the system operator considering system environments. In FIG. 5, as an example, the unit click cost is set at 60 won. Thus, there is an effect that it is possible to faithfully implement the purpose of the present invention to compute advertising costs based on the number of access connections of the searcher 130.

In the next, the goods information generating system 200 generates estimated advertising costs with respect to the second selling period for each seller, based on advertising costs of selling price and cost-per-click information (S840). This step S840 is a procedure for comparing sizes between the generated cost-per-click information and advertising costs of selling price and determining one advertising costs, to be estimated advertising costs of the next selling period. At this time, the determined advertising costs satisfies a predetermined criterion.

For this, the step S840 may include the step of determining estimated advertising costs. First, the goods information providing system 200 compares the cost-per-click information with advertising costs of selling price (S830). This step S830 is a procedure for comparing sizes with respect to two advertising costs computed under respectively different conditions. Thus, in this step, the comparative size between advertising costs of selling price and cost-per-click information is determined.

In addition, the goods information providing system 200 determines a smaller value between advertising costs of selling price and the cost-per-click information to be estimated advertising costs (S840). This step S840 is a procedure for determining advertising costs whose comparative size is compared to be small to be estimated advertising costs of the next selling period. Thus, there is an effect that it is possible to charge sellers more reasonable and low advertising costs through this.

In determining estimated advertising costs according to the present embodiment, as an example, advertising costs with a smaller amount is determined to be estimated advertising costs. This is only one embodiment of the present invention. Also, there may be various methods of determining estimated advertising costs, such as a method of determining the average between advertising costs of selling price and cost-per-click information, advertising costs with a larger amount, or the like, to be estimated advertising costs.

In the next, the goods information providing system 200 transmits the generated estimated advertising costs to the seller (S850). This step S850 is a procedure for providing the seller with information on advertising costs during the determined selling period such that the seller pays a corresponding amount. For example, in this step, a predetermined amount corresponding to the estimated advertising costs is received to an account associated with the seller. That is, in this step, the goods information providing system 200 controls a predetermined charging control means (not illustrated) to process a payment with respect to estimated advertising costs charged to the seller. For example, the goods information providing system 200 controls corresponding estimated advertising costs to be subtracted from an account associated with the seller.

In addition, as another embodiment of the present invention, truncation with respect to a predetermined digit of estimated advertising costs will be described.

FIG. 10 is a flowchart illustrating one example of a method for performing truncation with respect to estimated advertising costs.

That is, the goods information providing system 200 performs truncation with respect to a predetermined digit of determined estimated advertising costs (S1010). This step S1010 is a procedure for replacing the predetermined digit with ‘0’ in order to facilitate a payment with respect to advertising costs and to give the seller reduction of advertising costs. The digit corresponding to truncation may be flexibly set by the system operator considering system environments. For example, when the total digits of advertising costs are N, digits after N−1 can be ‘0’. Thus, estimated advertising costs ‘5,400 won’ with respect to the seller ‘Gmarket’ in FIG. 5 may be determined to be ‘5,000 won’ by performing truncation.

Accordingly, according to the present invention, it is possible to charge sellers low-priced advertising costs due to truncation. Also, it is possible to give sellers reduction of advertising costs. Thus, there is an effect that it is possible to induce sellers to continue to maintain advertising contracts.

Hereinafter, as another embodiment of the present invention, it will be described that the seller is induced to maintain an advertising contract by pre-payment of advertising deposit, in processing a payment by transmitting estimated advertising costs to the seller.

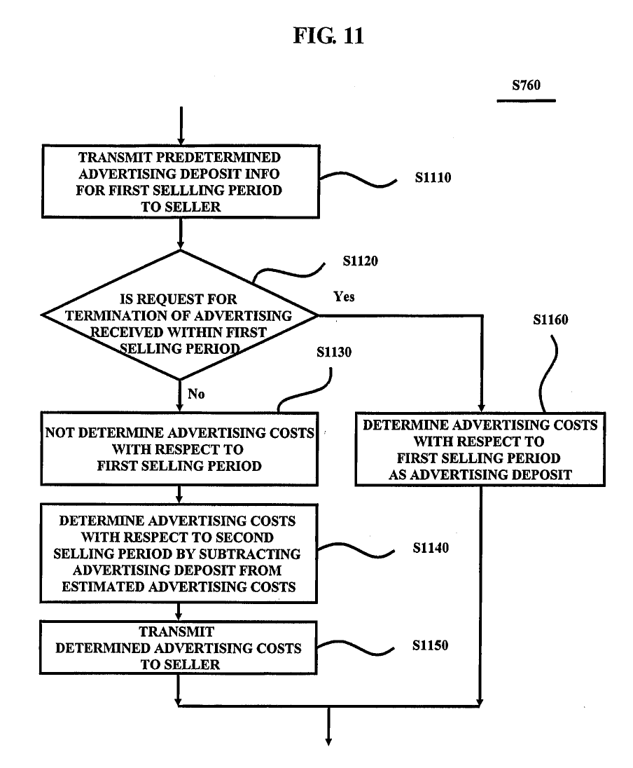

FIG. 11 is a flowchart illustrating one example of a method for determining advertising costs of a selling period based on payment of advertising deposit according to the present invention.

As illustrated in FIG. 11, the goods information providing system 200 transmits predetermined advertising deposit information with respect to the first selling period to the seller (S1110). This step S1110 is a procedure for transmitting information on set advertising deposit to the seller and inducing the seller to send an amount corresponding to the advertising deposit to a predetermined account. Advertising deposit may be security money with respect to the first selling period. In addition, advertising deposit may be an amount to be paid by the seller who terminates advertising within the first selling period which is free of charge. That is, advertising deposit prevents the seller from maintaining the advertising contract during the free first selling period only. Only when the seller further maintains the advertising contract with respect to the second selling period, advertising costs of the first selling period are free of charge. Thus, advertising deposit serves to induce the seller to maintain the advertising contract.

In addition, the goods information providing system 200 determines whether a request for termination of advertising is received from a predetermined seller within the first selling period (S1120). This step S1120 is a procedure for determining whether a request for termination of advertising is received with respect to stopping of advertising service. Thus, in this step, it is confirmed whether the seller intends to maintain the advertising service (a service abstracting a corresponding search listing in correspondence to a keyword) during the first selling period only.

In case that a request for termination of advertising is not received from the seller within the first selling period (no direction in S1120), the goods information providing system 200 does not determine advertising costs with respect to the first selling period (S1130). This step S1130 is a procedure for confirming that the seller has an intention to maintain the advertising contract during the second selling period and setting advertising costs for the first selling period to be ‘0’.

In the next, the goods information providing system 200 generates information on a bill for advertising costs with respect to the second selling period by subtracting advertising deposit from estimated advertising costs (S1140). This step S1140 is a procedure for generating advertising costs which will be actually charged with respect to the second selling period as information on a bill for advertising costs. In this step, after processing charge with respect to advertising deposit maintained in the account, the seller is induced to pay an additional payment corresponding to a remaining amount of the estimated advertising costs. For example, in case that ‘9,000 won’ estimated advertising costs are charged to the seller ‘buyis’, as illustrated in FIG. 5, under the condition that ‘1,000 won’ is maintained in a predetermined account as advertising deposit, the goods information providing system 200 of the present invention generates information on a bill for advertising costs with respect to the second selling period, ‘8,000 won’ (=9,000-1,000).

In addition, the goods information providing system 200 transmits the generated information on a bill for advertising costs to the seller (S1150). This step S1150 is a procedure for notifying the seller of advertising costs of the second selling period and charging the seller an amount corresponding to the transmitted information on a bill for advertising costs, for example, inducing the seller to pay an additional amount.

On the other hand, in case that a request for termination of advertising is received from the seller within the first selling period (yes direction in S1120), the goods information providing system 200 determines advertising deposit to be advertising costs of the first selling period (S1160). This step S1160 is a procedure for confirming that the seller has no intention to maintain the advertising contract further to second selling period and charging the seller advertising costs of the first selling period as a kind of penalty. Particularly, in this step S1160, the goods information providing system 200 determines advertising deposit maintained in the predetermined account to be advertising costs for the first selling period, and performs charging without an additional payment.

Accordingly, according to the present invention, advertising costs of the first selling period are free of charge with respect to the seller only who continues to maintain the advertising contract during the second selling period. Thus, there is an effect that it is possible to prevent sellers from leaving halfway.

Hereinafter, as another embodiment of the present invention, collecting of statistical information on a search trend of the searcher 130 who requests a search will be described.

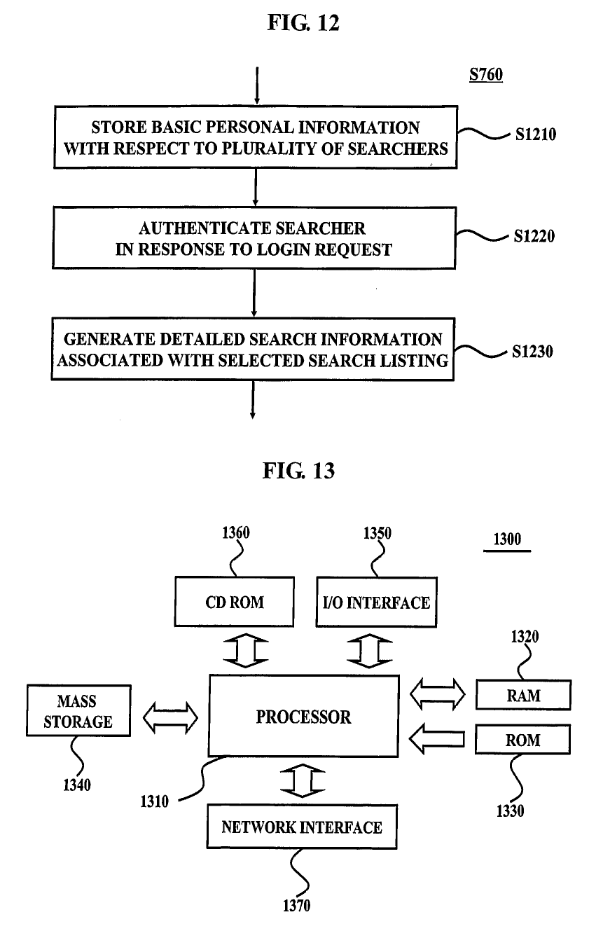

FIG. 12 is a flowchart illustrating one example of a method for generating detailed search information on a search trend of a searcher according to the present invention.

First, the goods information providing system 200 maintains a user information database for storing basic personal information on a plurality of searchers 130 (S1210). This step S1210 is a procedure for recording personal information data of the searcher 130. For example, personal information data in relation to user authentication is stored in a storage area of the user information database (not illustrated), which is allocated to each of searchers 130. The basic personal information may be received from the searcher 130, for example, when the searcher 130 accesses a server of the present system for the first time. In addition, the basic personal information may be updated at any time in accordance with a request of the searcher 130. The basic personal information may include a name of the searcher 130, a user identifier (a member ID), a password, a telephone number/a cellular phone number, a resident registration number capable of identifying a sex and a birth day, and the like, in order to authenticate the searcher 130.

In addition, the goods information providing system 200 authenticates the searcher 130 by referring to the user information database, in response to a predetermined login request received from the searcher 130 (S1220). This step S1220 is a procedure for receiving a user identifier or a password from the searcher 130 in which the user identifier or the password is required to authenticate the user. For example, when the user identifier or the password inputted by the searcher 130 in a user interface is identical to the basic personal information, the searcher 130 is authenticated. At this time, the user interface is associated with user authentication.

In the next, the goods information providing system 200 generates detailed search information associated with the selected search listing, in response to the received click selection (S1230). This step S1230 is a procedure for generating detailed search information recording information on a search trend of the searcher 130 when a click selection is received from the searcher 130 with respect to a search listing. That is, in this step S1230, the goods information providing system 200 records data in relation to a keyword inputted by the searcher 130 to request a search of goods, a kind of search listings abstracted in correspondence to the keyword, a search listing substantially selected by the searcher 130, and the like. The data may be classified in accordance with, for example, a sex of the searcher 130, an age thereof, an occupation thereof, and the like. The classified data may be provided to the system operator or the seller. Thus, there is an effect that the data helps sellers to establish sales strategies with respect to each of goods.

The embodiments of the present invention include computer readable media including program instructions to implement various operations embodied by a computer. The media may also include, alone or in combination with the program instructions, data files, data structures, tables, and the like. The media and program instructions may be those specially designed and constructed for the purposes of the present invention, or they may be of the kind well known and available to those having skill in the computer software arts. Examples of computer-readable media include magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). The media may also be a transmission medium such as optical or metallic lines, wave guides, etc. including a carrier wave transmitting signals specifying the program instructions, data structures, etc. Examples of program instructions include both machine code, such as produced by a compiler, and files containing higher level code that may be executed by the computer using an interpreter.

FIG. 13 is an inner block diagram of a general-purpose computer which can be adopted in implementing a method for providing goods information according to the present invention.

The computer system 1300 includes any number of processors 1310 (also referred to as central processing units, or CPUs) that are coupled to storage devices including primary storage (typically a random access memory, or “RAM 1320”, primary storage (typically a read only memory, or “ROM 1330”). As is well known in the art, ROM 1330 acts to transfer data and instructions uni-directionally to the CPU and RAM 1320 is used typically to transfer data and instructions in a bidirectional manner. Both of these primary storage devices may include any suitable type of the computer-readable media described above. A mass storage 1340 is also coupled bi-directionally to CPU and provides additional data storage capacity and may include any of the computer-readable media described above. The mass storage 1340 may be used to store programs, data and the like and is typically a secondary storage medium such as a hard disk that is slower than primary storage. A specific mass storage device such as a CD-ROM 1360 may also pass data uni-directionally to the CPU. Processor 1310 is also coupled to an interface 1350 that includes one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, processor 1310 optionally may be coupled to a computer or telecommunications network using a network connection as shown generally at a network interface 1370. With such a network connection, it is contemplated that the CPU might receive information from the network, or might output information to the network in the course of performing the above-described method steps. The above-described devices and materials will be familiar to those of skill in the computer hardware and software arts.

The hardware elements above may be configured to act as one or more software modules for implementing the operations of this invention.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching.

Also, method and system for providing goods information according to the present invention are embodied in a shopping mall providing a price comparison service and intended to charge reasonable advertising costs to an advertiser who is under predetermined contract with the price comparison service. However, this is only for convenience of description. It will be apparent to those skilled in the related art that the present invention may be applied to all the applicable examples such as exposing goods information under a predetermined condition and bringing various advertising effects to the advertiser. For example, the present invention may be applied when banner advertising with respect to predetermined goods is appeared and advertising costs in relation thereto are charged to the advertiser.

Therefore, it is intended that the scope of the invention be defined by the claims appended thereto and their equivalents.

Although the present invention has been described in connection with the embodiment of the present invention illustrated in the accompanying drawings, it is not limited thereto since it will be apparent to those skilled in the art that various substitutions, modifications and changes may be made thereto without departing from the scope and spirit of the invention.

### INDUSTRIAL APPLICABILITY

According to the present invention, there are provided method and system for providing goods information, which can compute advertising costs respectively by reflecting to the number of inputted clicks during a predetermined period and the total selling price of goods causing inputting of clicks and can determine supplementary advertising costs by charging a seller advertising costs whose comparative size is determined to be smaller as estimated advertising costs.

Also, according to the present invention, there are provided method and system for providing goods information, which can clearly confirm price information on the same goods at each of Internet shopping malls by sorting a search listing abstracted in correspondence to a keyword in accordance with selling price information and also can provide fine goods at low prices by causing price competition between Internet shopping malls.

Also, according to the present invention, there are provided method and system for providing goods information, which can prevent a seller from leaving halfway by providing free advertising with respect to a first selling period only for the seller who continues to maintain advertising with respect to a second selling period, by using advertising deposit received from the seller.

What is claimed is

1. A computer-implemented method for generating a list of search results of goods in response to a search request for goods of a searcher and providing the searcher with goods information, the method comprising the steps of:
maintaining a goods information database, the goods information database for storing at least one search listing, the search listing including seller identification information and selling price information;
receiving a search request for goods from a searcher;
providing a search result list of the goods in response to the search request for the goods, the search result list of the goods including the search listings;
detecting a click-through by the searcher of one of the provided search listings for the goods;
in response to the detected click-through, generating and storing total selling price information during a first predetermined period by referring to selling price information included in the selected search listing; and
generating advertising costs of selling price for each seller based, at least in part, upon a predetermined selling commission rate and the stored total selling price information.

2. The method of claim 1, comprising the steps of:
storing the detected click-through information of the selected search listing for each seller during the first predetermined period;
generating cost-per-click information in accordance with a predetermined unit click cost and the detected click-through information; and
providing estimated advertising costs for each seller with respect to a second selling period, based on the advertising costs of selling price and the cost-per-click information.

3. The method of claim 2, wherein the step of providing estimated advertising costs comprises the steps of:
comparing the advertising costs of selling price with the cost-per-click information; and
selecting determining a smaller value between the advertising costs of selling price and the cost-per-click information for the estimated advertising costs.

4-5. (canceled)

6. The method of claim 2, further comprising the steps of:
receiving predetermined deposit from a seller for advertising before the first predetermined period starts;
charging the seller's account with advertising costs for the second predetermined period based upon the estimated advertising costs;
providing the seller with outstanding balance information, the outstanding balance information being calculated by subtracting the predetermined deposit from the advertising costs for the second predetermined period.

7. The method of claim 2, further comprising the steps of:
receiving predetermined deposit from a seller for advertising before the first predetermined period starts; and
in case that a request for termination of advertising is received from the seller within the first selling period, charging the seller's account with the received deposit for the first predetermined period.

8-9. (canceled)

10. The method of claim 1, further comprising the steps of:
maintaining a user information database, the user information database for storing basic personal information on a plurality of searchers;
in response to a predetermined login request received from the searcher, authenticating the searcher by referring to the user information database; and
in response to the received click selection, generating detailed search information on goods associated with the selected search listing and storing the same in the user information database.

11. The method of claim 1, further comprising the step of:
generating advertising costs of selling price with respect to each of the sellers, by applying at least one different exemplary selling commission rate to total selling price with respect to each of the sellers during a predetermined period;
wherein the selling commission rate is determined to be the applied exemplary selling commission rate when the total amount of the advertising costs of selling price with respect to the plurality of sellers during the predetermined period is nearest to the total amount of the cost-per-click information with respect to the plurality of sellers during the predetermined period.

12. A computer-implemented method for generating a list of search results of goods in response to a search request for goods of a searcher and providing the searcher with goods information, the method comprising the steps of:
maintaining a goods information database, the goods information database for storing at least one search listing, the search listing including seller identification information and selling price information;
receiving a search request for goods from a searcher;
providing a search result list of the goods in response to the search request for the goods, the search result list of the goods including the search listings;
detecting a click-through by the searcher of one of the provided search listings for the goods;
in response to the detected click-through, generating and storing click-through information and total selling price information with respect to a first selling period for each seller;
generating predetermined advertising costs of selling price and cost-per-click information by referring to the stored total selling price information and click selection information, the total selling price information being generated by accumulating selling price information of the selected search listing, the click selection information being generated by accumulating the number of selections with respect to the search listing;
generating estimated advertising costs with respect to a second selling period, based on the generated advertising costs of selling price and the generated cost-per-click information; and
providing a seller with the generated advertising costs information.

13. The method of claim 12, wherein the step of generating the predetermined advertising costs of selling price and cost-per-click information comprises the steps of:
generating advertising costs of selling price by applying a predetermined selling commission rate to the stored total selling price information for each seller by referring to the seller identification information; and
generating cost-per-click information in accordance with a predetermined unit click cost based on the stored click selection information for each seller.

14. A computer-implemented method for providing a user with goods information through the Internet, the method comprising the steps of:
maintaining a goods information database, the goods information database for storing at least one search listing, the search listing including seller identification information and selling price information;
providing the user with goods information on at least one goods;
receiving a selection of a user with respect to any one of goods information provided to the user;
in response to the selection, computing total selling price information and click selection information with respect to a predetermined period for each seller;
generating predetermined advertising costs of selling price and cost-per-click information by referring to the computed total selling price information and click selection information;
generating estimated advertising costs with respect to a second selling period, based on the generated advertising costs of selling price and cost-per-click information; and
providing a seller with the generated estimated advertising costs.

15. The method of claim 14, wherein the step of generating and computing total selling price information and click selection information with respect to the predetermined period comprises the steps of:
computing the total selling price information by adding up the selling price of goods for each seller selected by the user during the predetermined period; and
computing the click selection information, which is the number of times that the user clicks goods information on goods of each seller during the predetermined period, for each seller.

16. A computer readable record medium recording a program for implementing the method according to claim 1.

17. A system for generating a list of search results of goods in response to a search request for goods of a searcher and providing the searcher with goods information, the system comprising:
a goods information database, the goods information database storing a search listing including seller identification information and selling price information;
an interface, the interface receiving a search request for goods including a keyword from a searcher;
a list generating module, in response to the search request for goods, the list generating module abstracting at least one search listing associated with the keyword from the goods information database, the list generating module generating a list of search results of goods and transmitting the same to the searcher;
a record control module, in response to the received click selection of the searcher selecting any one search listing among the list of search results of goods, the record control module generating and storing click selection information and total selling price information with respect to a first selling period for each seller;
a first advertising costs generating module, the first advertising costs generating module generating predetermined advertising costs of selling price and cost-per-click information by referring to the stored total selling price information and click selection information;
a second advertising costs generating module, the second advertising costs generating module generating estimated advertising costs information with respect to a second selling period, based on the generated advertising costs of selling price and cost-per-click information.

18. The method of claim 1, wherein the step of providing the search result list of the goods comprises the step of:
sorting the at least one search listing in accordance with a predetermined criterion based on selling price information of the search listing.
